(19) United States
(12) Patent Application Publication
(10) Pub. No.: US 2004/0146172 A1
(43) Pub. Date: Jul. 29, 2004

(54) Wearable personal audio system

(76) Inventors: Vinod Kumar Goswami, Chestnut Hill, MA (US); Vinita Goswami, Chestnut Hill, MA (US); Sanjeev Goswami, Decatur, GA (US)

Correspondence Address: Kaplesh Kumar, Law Office, 25 Redwing Road, Wellesley, MA, 02481, US

(21) Appl. No.: 10/753,919

(22) Filed: Jan. 7, 2004

Related U.S. Application Data
(60) Provisional application No. 60/438,840, filed on Jan. 9, 2003.

(51) Int. Cl. H04B 1/08; H04R 25/00

(52) U.S. Cl. 381/378; 381/370; 455/351

(57) ABSTRACT

A flexible and manipulable wearable personal audio system for use with contemporary portable entertainment and other audio devices. The system includes a flexible manipulable member, speakers, and an audio source in communication with the speakers. A light source is provided optionally. The flexible manipulable member can be adjusted within a range of shapes and lengths. Speakers positioned within the flexible and manipulable member are excited by signals from an audio source. The audio source can be hard-wired to the speakers or be in communication with them using a wireless connection.

This application claims the benefit of U.S. Provisional Application No. 60/438,840 filed on Jan. 9, 2003.

### BACKGROUND OF THE INVENTION

The present invention relates generally to a personal audio system, and more specifically to a wearable personal audio system with a flexible and manipulable structure that can be used with contemporary portable entertainment, communication, and audio devices.

Although personal audio systems, comprising headsets with speakers driven by audio modules, have been in use for years, they have a number of limitations. They are uncomfortable for long term use due to the pressure from the speakers on the ear drums and the clamping of the headset on the head. They can be easily dislodged if the user engages in physical activity such as jogging, biking, and roller blading. And, safety is generally compromised, since the speakers covering or located next to the ears interfere with other sounds from reaching the ear drums, so that the user is less aware of his surroundings.

As an example, U.S. Pat. No. 5,953,434, issued Sep. 14, 1999 to James H. Boyden, describes a head band incorporating speakers positioned on either side of the wearer's head adjacent to the ears. The speakers communicate with audio sources, transmitting their sound to the wearer of the head band. U.S. Pat. No. 5,680,465, issued Oct. 21, 1997 to James H. Boyden, similarly describes a device comprising a head band constructed from acoustically transparent material and speakers. The speakers are positioned adjacent to the user's ears, or alternatively around the neck. U.S. Pat. No. 6,091,832, issued Jul. 18, 2000 to Daniel Sherman, allows for positioning such a personal audio system around the neck by providing a loop construction.

While wearing the audio systems on parts of the body other than the head allows the pressure on the ears and the head to be relieved, such devices are limited in how well they are secured to the user. For instance, during physical activity, the audio loop has the potential to become dislodged from its position. Furthermore, such systems provide for a standard size of construction, although human beings exist in a range of sizes.

The pressure on the ears can also be avoided by conducting sound from the speakers to the auditory organs through means such as human bone and tissue. An example is U.S. Pat. No. 6,456,721, issued Sep. 24, 2002 to Mikio Fukuda, describing a headset fitted with bone conduction speakers. However, human bone and tissue attenuate high frequencies and additional signal processing is required to render fidelity to the sound conducted exclusively this way. The quality of the sensed sound can be increased by positioning the speakers selectively to certain hard parts of the head, or augmenting the bone-conducted sound with other means of sound conduction.

### BRIEF SUMMARY OF THE INVENTION

The present invention provides a wearable personal audio system possessing the advantages of the prior art personal audio systems, but excluding their limitations. A number of novel features are included, resulting in a wearable personal audio system that is not anticipated, rendered obvious, suggested, or implied by the prior art. A personal wearable audio system having a flexible and manipulable structure is provided for use with portable entertainment, communication, and audio sources.

The invention herein comprises a flexible and manipulable tubular support member, speakers enclosed within the said support member, a source of audio signals in communication with the speakers, hard wiring or wireless transmission provided for said communication between the speakers and the audio sources, and a light source. Appropriate switching and power sources are included as required.

The speakers, positioned within the flexible and manipulable tubular member, transduce the audio signal from one or more internal or external sources. Flexible and manipulable support member structures are known in the art. One such structure is described in U.S. Pat. No. 5,395,278, issued Mar. 7, 1995 to H. Dickhut. The flexible and manipulable support member can adjust to any shape and length within a wide range of permitted lengths and geometries determined by the support member's diameter and initial designed length limitations as to the fully extended and fully compacted states. Thus, the user can secure or accommodate this personal audio system to obtain a snug and nearly pressure-less fit on any desired part of his body without experiencing discomfort.

The acoustic functionality of the flexible and manipulable support member of the present invention is augmented by holes selectively perforating its walls. Sources for audio signals can be a radio, cell phone, disc music player, digital music player, or other video/audio equipment. The light source includes glow-in-the-dark material or a light emitting diode, LED, located within the tubular member. Alternative audio and light sources are within the scope of the invention.

The light source also serves a safety function since the wearer of the personal audio system can be seen in the dark by a passing motorist, cyclist, or operator of other similar vehicle. The light source may be sound or motion activated or modulated to enhance the viewing pleasure, if desired.

There have thus been outlined, rather broadly, the more significant features of the invention in order that the detailed description thereof may be better understood and the present contribution to the art better appreciated.

A primary object of the present invention is to provide a wearable personal audio system that overcomes the shortcomings of the prior art devices.

A second object of the present invention is to provide a flexible and manipulable wearable personal audio system that can be used with contemporary portable entertainment, communication, and audio sources or devices.

Another object of the present invention is to provide a wearable personal audio system that a user can wear around the head or neck or other parts of his body to enjoy with little to no discomfort the sound from both fixed and portable audio sources, located within or outside the said personal audio system.

Yet another object of the present invention is to provide a wearable personal audio system that is easily be worn and does not interfere with routine physical activities.

Still another object of the present invention is to provide a wearable personal audio system that is decorative in appearance and can be illuminated with glow-in-the-dark material or a light source within the device.

A further object of the present invention is to provide a wearable personal audio system that does not require the speakers to contact, or be positioned near or over, the wearer's ears, and whose shape and design can be customized by the user to suit the type of environment and clothing style.

Another object of the present invention is to provide a wearable personal audio system in which the speakers communicate with internal or external audio sources with a hard wired or wireless connection.

Other objects and advantages of the present invention will be obvious to the person of ordinary skill in the art, and are within its spirit and scope.

To accomplish the above and related objects, this invention may be embodied in the form illustrated in the accompanying drawings. The drawings and description herein, however, are for illustration only. The scope of the invention is limited only by the claims and not by the drawings or description herein.

### BRIEF DESCRIPTION OF THE SEVERAL VIEWS OF THE DRAWING

The objects, features, and attendant advantages of the present invention are more fully understood when considered in conjunction with the accompanying drawings, in which like reference characters designate the same or similar parts throughout the several views:

FIG. 1 shows the principal parts of the present invention.

FIG. 2 has views of the tubular member of present invention in different shapes and lengths with the ends open or secured to form a closed loop.

FIG. 3 shows the speaker assembly and its installation into the tubular member, with an option for including electronic circuitry designed for wireless audio signal reception.

FIG. 4 shows a preferred embodiment of the present invention by way of illustration.

FIG. 5 presents additional embodiments of the preferred invention.

FIG. 6 depicts an open ended embodiment of the present invention.

FIG. 7 shows views of the present invention when worn around the head, where the audio source is either within or outside the tubular member.

FIG. 8 shows views of the present invention when worn around the neck, where the audio source is either within or outside the tubular member.

### DETAILED DESCRIPTION OF THE INVENTION

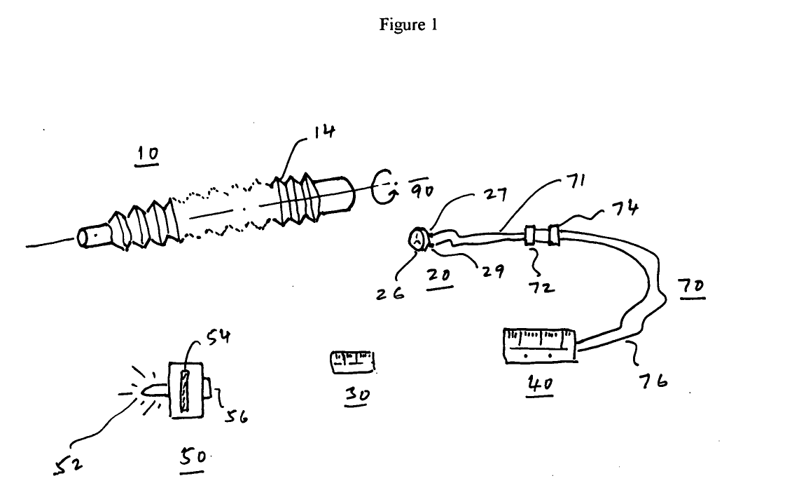

FIG. 1 shows a schematic representation of the principal parts of the wearable personal audio system comprising the present invention: a flexible and manipulable tubular member 10; speakers 20; internal audio source 30 or external audio source 40; and internal light source 50 or illumination from glow-in-the-dark material incorporated within the said tubular member 10. Communication means 70 are provided between speakers 20 and internal audio source 30 or between speakers 20 and external audio source 40.

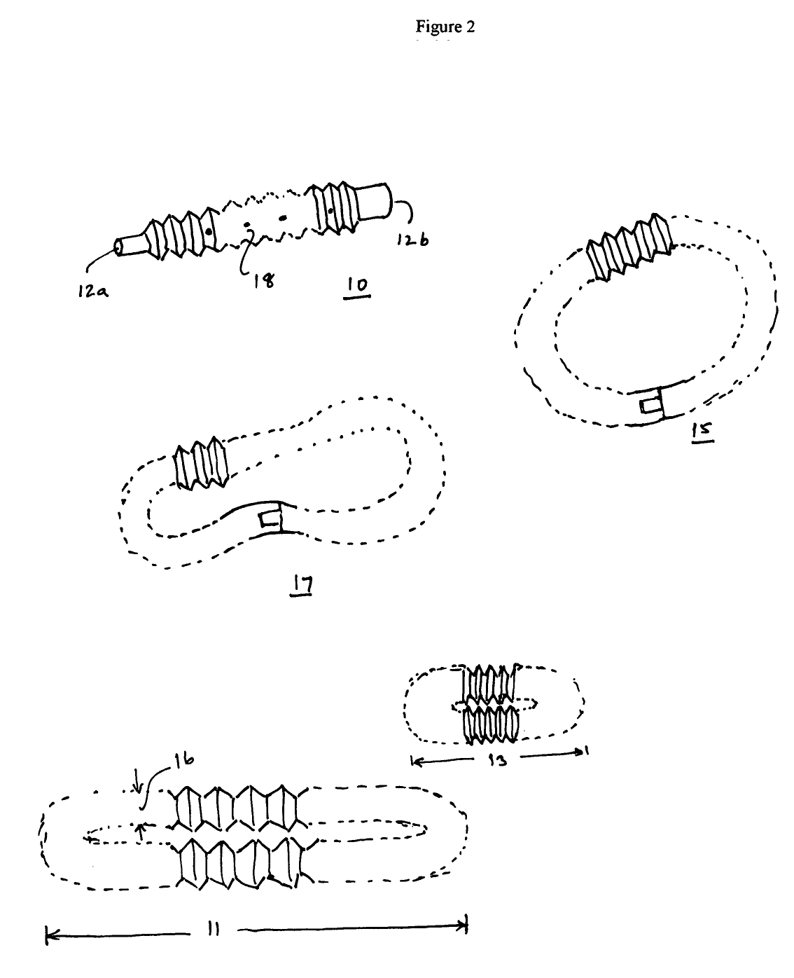

The flexible and manipulable tubular structure 10 is preferably fabricated from a semi-rigid material, such as a translucent plastic. The manipulable member 10 is preferentially of tubular construction whose wall 14 defines a hollow cavity with a circular or other cross section disposed normally to the cavity longitudinal axis 90. In the unassembled condition, manipulable member 10 has two open ends 12a and 12b, which are constructed so that the open end 12a can telescope into open end 12b and be received within open end 12b with a tight frictional fit to render a closed loop structure 15. FIG. 2. The attached ends are preferably secured additionally with a suitable adhesive. The tubular member 10 has holes 18 of various sizes at appropriate locations to enhance the multi-dimensional audio experience.

The open structure 10 or closed loop structure 15 can be flexibly manipulated into any arbitrary shape 17, the range of options limited only by the diameter 16 and lengths 11 and 13 in the fully expanded and fully compressed states, respectively, of the flexible manipulable member 10. In the open 10 or closed 15 loop configurations, the tube or any portion thereof is expandable, retractable, and manipulable into various curvilinear configurations. It maintains the last chosen extended, retracted, or curvilinear condition.

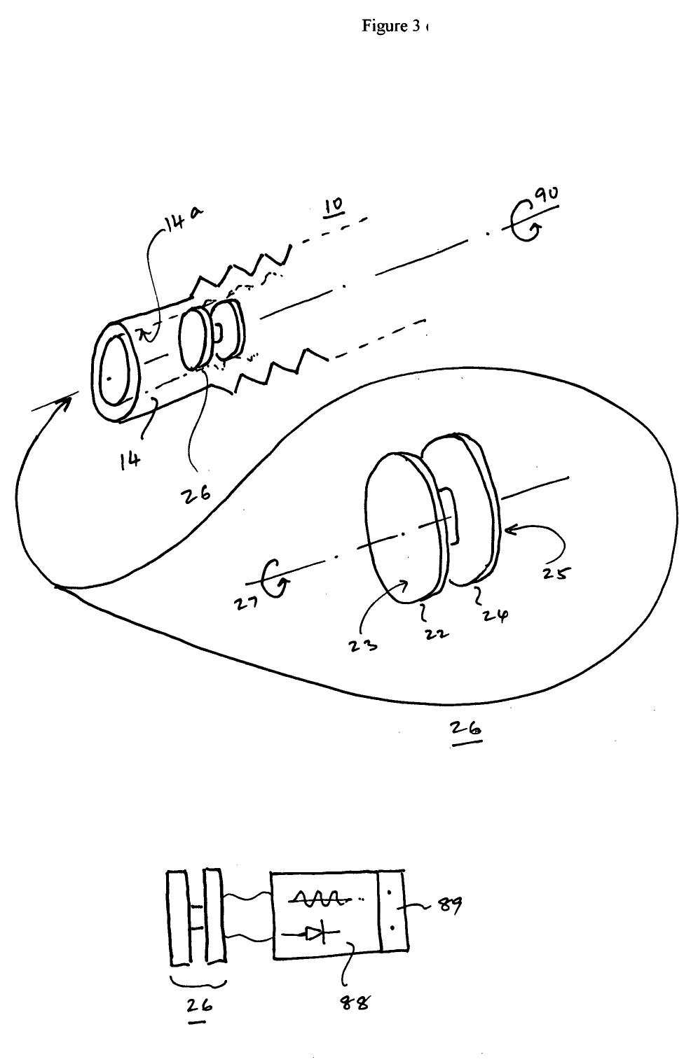

Although the invention may be practiced with just one speaker 20, two speakers 22 and 24 are preferably formed as an assembly 26 and inserted into open end 12a of the flexible and manipulable member 10 and secured to the interior surface 14a of wall 14. FIG. 3.

Prior to insertion, the speakers 22 and 24 are assembled by preferably fixedly attaching them to each other as a back to back assembly 26, so that sounds emanating from speakers 22 and 24 will be directed and propagated in opposing directions. The speaker assembly is positioned inside the manipulable member 10 so that its axis 27, normal to flat planes 23 and 25 of speakers 22 and 24 respectively from which the sounds are launched, is coincidental at that location with the longitudinal axis 90 of the tubular manipulable member 10. The speaker assembly 26 is preferably secured to the interior surface 14a of wall 14 of the tubular member 10 using a suitable adhesive. A multiplicity of additional speakers may be located in the tubular member 10 for additional sound effects.

When the speakers 26 are excited by an internal audio source 30 or external audio source 40 using communication means 70, they fill the space enclosed by the wall 14 of the tubular member 10 with sound. Leads 71 from the speakers 26 are attached to connector 72 to which the audio source 30 or 40 can be mated electrically by means of connector 74 attached to a cord 76 of the audio source 30 or 40. FIG. 1. Where the drive signal is from an internal audio source 30, connectors 72 and 74 may be optionally dispensed with and the leads from the audio source connected directly to the speaker 22 and/or 24 terminals 27 and 29 respectively. Examples of audio sources include without limitation portable radios, disc music player, digital music player, video games, and cell phones.

Alternatively, suitable compact electronic circuitry 88 powered by a local power source 89 may be provided with the speaker assembly 26 for wireless reception of signals from the remote audio source 40 and suitable signal processing to drive the speakers 26. The audio sources 30 or 40 can be tuned manually by the wearer for the desired frequencies or preprogrammed to selected frequencies with functional logic, e.g.: Global Positioning System (GPS). For instance, the GPS receiver chip circuitry can determine the location of the wearer and suitably select an appropriate radio station in the area according to the wearer's preferences.

The flexible and manipulable tubular member 10 is illuminated preferably by a self-contained light source 50, or optionally by using glow-in-the-dark material. The internal light source consists of a light bulb 52, such as a light emitting diode, a power source 54, such as a thin film battery, and a switch 56. FIG. 1. A manually operated switch provides greater control to the wearer of the personal audio system and is preferably provided. For special visual effects, the switch 56 can be optionally activated or modulated by motion or sound. A glowing or well-illuminated personal audio system provides a safety function in the dark by alerting motorists, cyclists, and operators of similar other vehicular traffic of the wearer's presence.

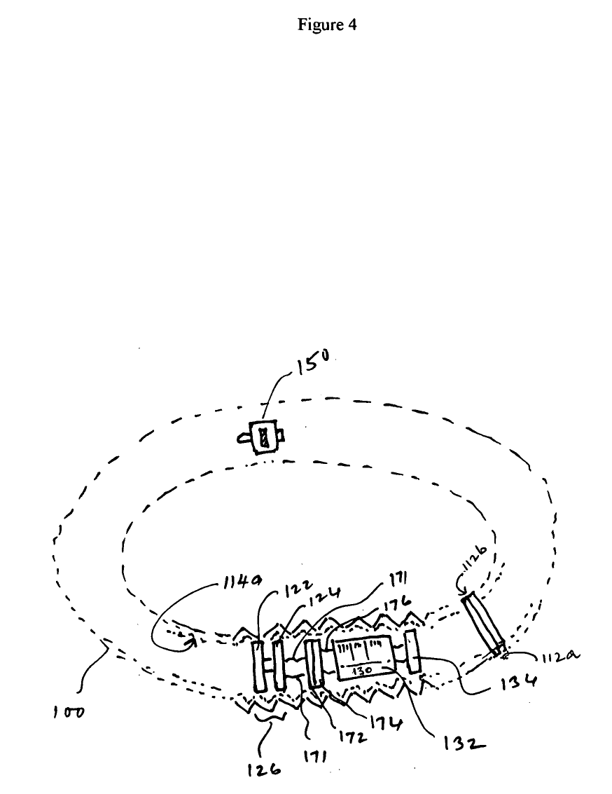

By way of illustration only, and not any limitation, FIG. 4 shows a preferred embodiment of the present invention. The personal audio system depicted therein utilizes a flexible and manipulable tubular member 100 of the type similar or equivalent to that disclosed in U.S. Pat. No. 5,395,278. The speaker assembly 126 is constructed from two speakers 122 and 124, similar or equivalent to model KDM-20008 from Kingstate Electric Corporation, Taiwan, in a back-to-back configuration. A light source assembly 150, comprising a high luminous LED, similar or equivalent to model E1L533BL from Hiyoshi Electric Co. Ltd., Tokyo, Japan and powered by a miniature battery similar or equivalent to model CR-2032 from Camelion Batteries, GmbH, Berlin, Germany, is inserted into open end 112a and secured to the interior surface 114a of wall 114. The speaker assembly 126 with its leads 171 terminating into connector 172 is next inserted into the open end 112a and secured to the interior surface 114a of wall 114, preferably using an adhesive. An audio source 130 comprising a radio 132 and power source 134 with leads 176 and connector 174 is inserted into the open end 112b, connectors 172 and 174 are mated each other, and the audio source 130 fixedly attached to said interior surface 114a of wall 114. After capturing them within the tubular cavity defined by wall 114, open end 112a is telescoped into open end 112b and fixedly attached to it, preferably with a suitable adhesive.

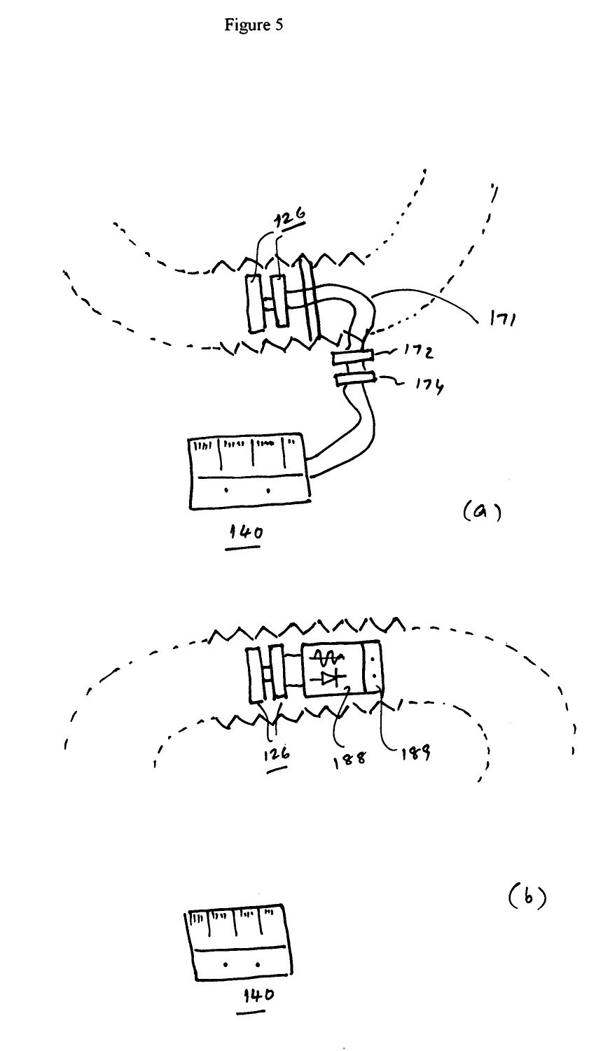

In another embodiment of the preferred invention, shown in FIG. 5, the audio source 140 is provided external to the tubular member 110, and means for egress of the speaker leads 171 and connector 172 provided at the attachment of the two open ends 112a and 112b. This way the connector 172 becomes available for attaching to the mating connector 174 of external audio source 140 so that the speaker assembly 126 is driven by the electrical signals from the audio source 140.

In yet another embodiment of the preferred invention, compact electronic circuitry 188 powered by a local power source 189 may be provided with the speaker assembly 126 for wireless reception of the signals from the local audio source 130 or remote audio source 140 to drive the speakers 126. As before, the audio sources 130 or 140 can be tuned manually by the wearer for the desired frequencies or preprogrammed to selected frequencies by use of functional logic, e.g.: Global Positioning System (GPS).

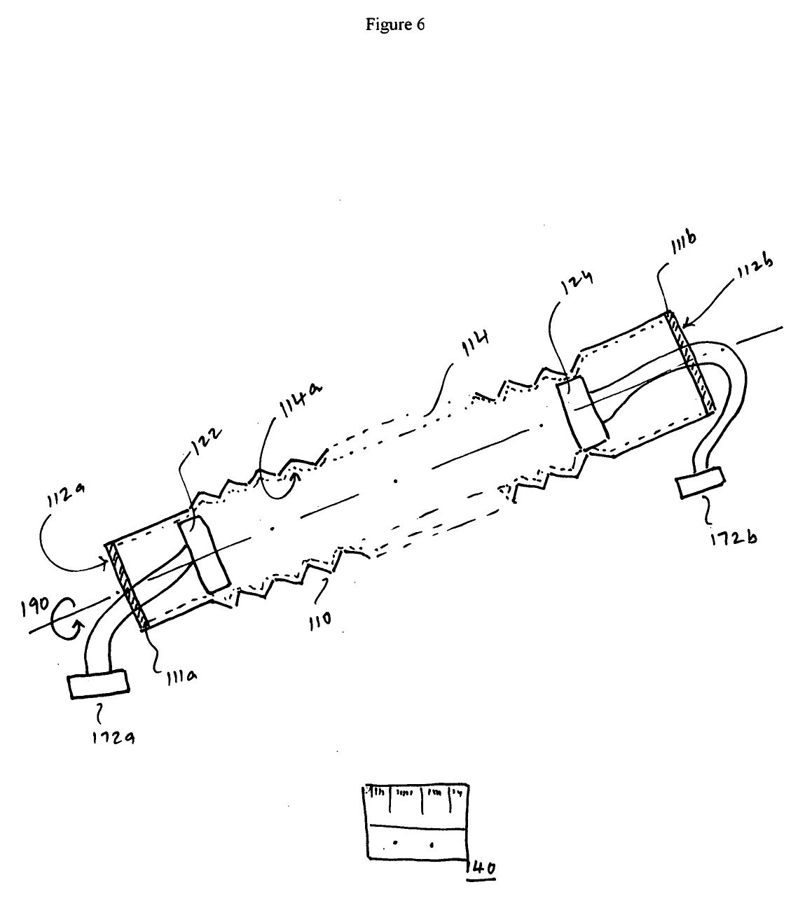

In still another embodiment of the present invention, shown in FIG. 6, the speakers 122 and 124 are not installed as an assembly but inserted individually into the two open ends 112a and 112b respectively of the tubular member 110 where they are secured to the interior surface 114a of wall 114 and then captured and sealed within the cavity defined by wall 114 and end caps 111a and 111b respectively. Here, the two connectors 172a and 172b, attached respectively to speakers 122 and 124, are available separately for coupling with the mating connectors of the external audio source 140. The sounds from speakers 122 and 124 are propagated in opposite directions along the axis 190 of the tubular cavity defined by the end caps 111a and 111b and wall 114 of the tubular member 110. In this embodiment, the tubular member 110 of the personal audio system may not form a closed loop but remain available as a flexible and manipulable open ended structure.

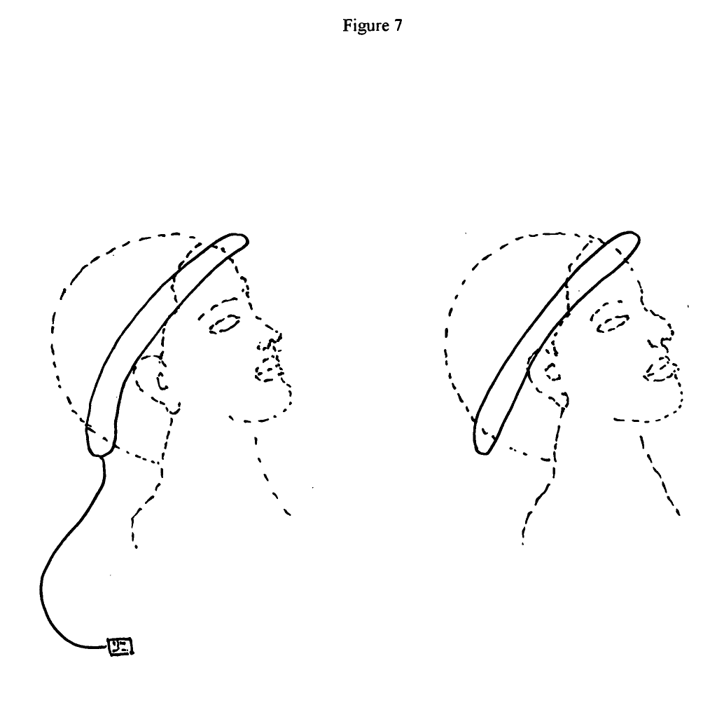

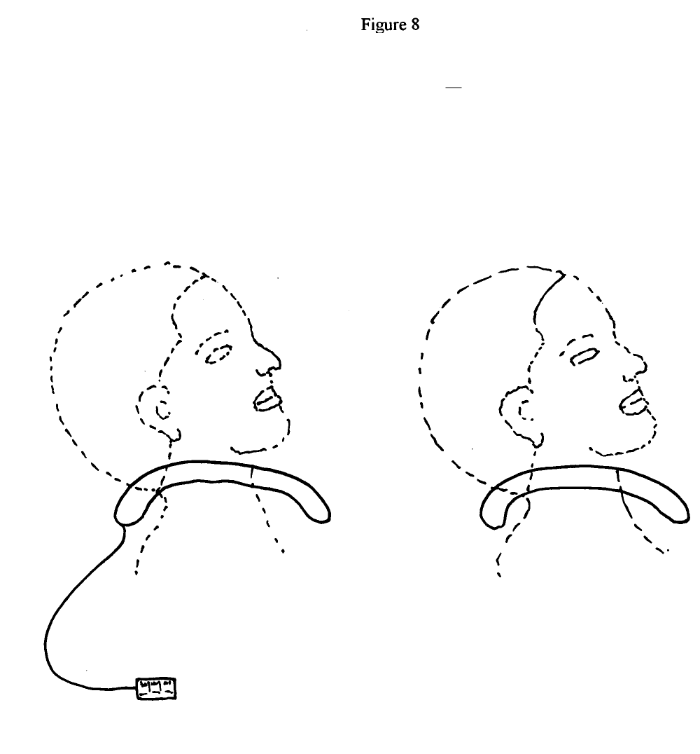

The wearable personal audio system comprising the present invention offers a large flexibility to the user. It can be manipulated into a variety of closed loop and open ended shapes and lengths, as shown in FIG. 2. It can be designed with glow in the dark materials or a light source internal to the flexible and manipulable tubular member. The audio source can be internal or external to said tubular member. It may be worn by the user around various parts of the body, such as around the head, as in FIG. 7, or around the neck, as in FIG. 8. This heightens the experience via bone conduction and sensorineural hearing. The speakers can be connected to the audio source using industry standard cables and jacks serving as the mating connectors. Because of its flexible and manipulable nature, the device can be adjusted to different sizes and shapes to selectively conform to the contours of one's body.

The present invention is not limited in its application to the details of construction or the arrangements of the components set forth in the embodiments herein or illustrated in the drawings. Suitable modifications and desired relationships between the discrete components of the present invention, including variations in sizes, materials, shapes, form, function, manner of operation, assembly, and use, would be readily apparent to one of ordinary skill in the art. All such embodiments are within the scope of the present invention.

It is understood that the phraseology and terminology employed herein in describing the invention shall not be regarded as limiting. The device comprising the present invention is to be limited only by the claims herein presented and not by what has been particularly described in the specification.

I claim:

1. A wearable personal audio system comprising:
a manipulable tubular member having a flexible semi-rigid wall with an interior surface terminating at its first and second open ends, said open ends capable of being fixedly secured to each other to render a closed loop tubular structure;
at least two speakers secured to the interior surface of said semi-rigid wall;
at least one audio source in communication with the speakers; and
at least one light source secured to the interior surface of the semi-rigid wall.

2. The system of claim 1 wherein the manipulable tubular member is a closed loop tubular structure.

3. The system of claim 1 wherein communication between the speakers and the audio source includes mating connectors attached to said speakers and audio source.

4. The system of claim 1 wherein communication between the speakers and the audio source includes establishing a wireless connection between them.

5. The system of claim 1 wherein the audio source comprises a radio.

6. The system of claim 1 wherein the audio source comprises a cell phone.

7. The system of claim 1 wherein the audio source comprises a disc music player.

8. The system of claim 1 wherein the audio source comprises a digital music player.

9. The system of claim 1 wherein the audio source comprises a video game input.

10. The system of claim 2 wherein the flexible manipulable tubular member is made from a semi-rigid plastic of bellows construction.

11. The system of claim 2 wherein the manipulable tubular member has holes perforating its semi-rigid wall.

12. The system of claim 1 wherein the speakers are adhesively secured to the interior surface of the semi rigid wall.

13. The system of claim 1 wherein the light source is a light emitting diode.

14. The system of claim 13 wherein the light emitting diode is energized with a battery activated by a switch.

15. The system of claim 14 wherein the switch is activated with sound.

16. The system of claim 14 wherein the switch is activated manually.

17. The system of claim 14 wherein the switch is activated with motion.

18. The system of claim 1 wherein said open ends can be secured to each other by telescoping the first end into the second open end so that said first end is received intimately in a tight frictional fit within said second end.

19. The system of claim 18 wherein the first and second end are further secured using an adhesive.

20. A wearable personal audio system comprising:
a manipulable tubular member having a flexible semi-rigid wall with an interior surface terminating at its first and second open ends, said open ends capable of being fixedly secured to each other to render a closed loop tubular structure;
at least two speakers secured to the interior surface of said tubular member;
and at least one audio source in communication with the speakers.

21. The system of claim 20 wherein the manipulable tubular member is a closed loop tubular structure.

22. The system of claim 20 wherein communication between the speakers and the audio source includes mating connectors attached to said speakers and audio source.

23. The system of claim 20 wherein communication between the speakers and the audio source includes a wireless connection.

24. The system of claim 20 wherein the audio source comprises a radio.

25. The system of claim 20 wherein the audio source comprises a cell phone.

26. The system of claim 20 wherein the audio source comprises a disc music player.

27. The system of claim 20 wherein the audio source comprises a digital music player.

28. The system of claim 20 wherein the audio source comprises a video game input.

29. The system of claim 21 wherein the flexible manipulable tubular member is made from a semi-rigid plastic of bellows construction.

30. The system of claim 21 wherein the manipulable tubular member has holes perforating its semi-rigid wall.

31. The system of claim 20 wherein the speakers are adhesively secured to said interior surface of the semi rigid wall.

32. The system of claim 20 wherein said open ends can be secured to each other by telescoping the first end into the second open end so that said first end is received intimately with a tight frictional fit within said second end.

33. The system of claim 32 wherein the first and second end are further secured using an adhesive.

34. A wearable personal audio system comprising:
a manipulable tubular member having a flexible semi-rigid wall with an interior surface terminating at its first and second open ends, said open ends capable of being fixedly secured to each other to render a closed loop tubular structure;
at least one speaker secured to the interior surface of said tubular member; and
and at least one audio source in communication with the speakers.

35. The system of claim 34 wherein the manipulable tubular member is a closed loop tubular structure.

36. The system of claim 34 wherein communication between the speakers and the audio source includes mating connectors attached to said speakers and audio source.

37. The system of claim 34 wherein communication between the speakers and the audio source includes establishing a wireless connection with the audio source.

38. The system of claim 34 wherein the audio source comprises a radio.

39. The system of claim 34 wherein the audio source comprises a cell phone.

40. The system of claim 34 wherein the audio source comprises a disc music player.

41. The system of claim 1 wherein the audio source comprises a digital music player.

42. The system of claim 34 wherein the audio source comprises a video game input.

43. The system of claim 35 wherein the flexible manipulable tubular member is made from a semi-rigid plastic of bellows construction.

44. The system of claim 35 wherein the manipulable tubular member has holes perforating its semi-rigid wall.

45. The system of claim 34 wherein the speakers are adhesively secured to said interior surface of the semi rigid wall.

46. The system of claim 34 wherein said open ends can be secured to each other by telescoping the first end into the second open end so that said first end is received intimately within said second end.

47. The system of claim 46 wherein the first and second end are further secured using an adhesive.
